(19) United States
(12) Patent Application Publication
(10) Pub. No.: US 2019/0236343 A1
(43) Pub. Date: Aug. 1, 2019

(54) GESTURE DETECTION DEVICE

(71) Applicant: DENSO CORPORATION, Kariya-city, Aichi (JP)

(72) Inventor: Toshiyuki KONISHI, Kariya-city (JP)

(21) Appl. No.: 16/332,898

(22) PCT Filed: Jul. 18, 2017
(86) PCT No.: PCT/JP2017/025867

§ 371 Date: Mar. 13, 2019

(30) Foreign Application Priority Data
Sep. 27, 2016 (JP) 2016-188446

(51) Int. Cl. G06K 9/00; G06F 3/01; G06T 7/70

(52) U.S. Cl. CPC G06K 9/00335; G06K 9/00228; G06T 7/70; G06F 3/017

(57) ABSTRACT

A gesture detection device that detects a gesture of an operator who changes a face direction while visually observing a target display object displayed in a display area, includes: a line-of-sight detection section that detects a line-of-sight direction of the operator according to a captured image of an imaging unit; a face direction detection section that detects a face direction of the operator according to the captured image; and a gesture determination section that compares a first time at which the operator starts changing the face direction with a second time at which the operator starts changing the line-of-sight direction, and determines whether the gesture is performed, according to a delay of the second time relative to the first time in addition to an expansion of a difference between the line-of-sight direction and the face direction.

### CROSS REFERENCE TO RELATED APPLICATION

This application is based on Japanese Patent Application No. 2016-188446 filed on Sep. 27, 2016, the disclosure of which is incorporated herein by reference.

### TECHNICAL FIELD

The present disclosure relates to a gesture detection device that detects a gesture of an operator.

### BACKGROUND ART

As a conventional technique, for example, Patent Literature 1 discloses, as a kind of a technique that detects a gesture, a recognition device that detects both a line-of-sight direction and a face direction of an operator by using image data of a camera that captures an image of the operator. The recognition device determines that a gesture that indicates an intention of the operator is present on the basis of the difference between the line-of-sight direction and the face direction of the operator.

### PRIOR ART LITERATURE

### Patent Literature

Patent Literature 1: JP-2007-94619-A

### SUMMARY OF INVENTION

The inventor of the present disclosure has developed a gesture detection device using the technique of Patent Literature 1. Specifically, the gesture detection device displays a display object such as an icon on a display screen. When an operator makes a gesture in which the operator changes a face direction while visually observing the display object, the gesture detection device detects an expansion of the difference between the line-of-sight direction and the face direction to determine that the gesture has been input. Such a gesture detection device enables the operator to input an operation without using his/her hand.

However, it is difficult to obtain an excellent operability only by the process of determining the presence or absence of a gesture on the basis of the expansion of the difference between the line-of-sight direction and the face direction. Specifically, when an operator makes a gesture, the operator unconsciously moves not only the face direction, but also the line of sight in the same direction as the face direction. As a result, the difference between the line-of-sight direction and the face direction is difficult to expand, and the determination that the gesture is present is apt to be delayed. The determination that the gesture is present may be made at the stage when the difference between the line-of-sight direction and the face direction is small to solve such a defect. However, in such a case, even when a mere line-of-sight movement in which the line of sight is turned away from the display screen is made, the gesture detection device may erroneously determine that a gesture is present.

It is an object of the present disclosure to provide a gesture detection device that achieves both reduction of erroneous determination and a smooth input of a gesture, and has an excellent operability.

According to an aspect of the present disclosure, a gesture detection device that detects a gesture of an operator who changes a face direction while visually observing a target display object displayed in a display area, includes: a line-of-sight detection section that detects a line-of-sight direction of the operator according to a captured image of an imaging unit that captures an image of the operator; a face direction detection section that detects a face direction of the operator according to the captured image; and a gesture determination section that compares a first time at which the operator starts changing the face direction with a second time at which the operator starts changing the line-of-sight direction, and determines whether the gesture is performed with respect to the target display object, according to a delay of the second time relative to the first time in addition to an expansion of a difference between the line-of-sight direction and the face direction.

The inventor has focused on the fact that there is a difference between the first time at which the change of the face direction is started and the second time at which the change of the line-of-sight direction is started when the operator makes a mere line-of-sight movement and when the operator makes a gesture. Specifically, in a mere line-of-sight movement, the operator tends to change the line-of-sight direction first and then change the face direction. On the other hand, when the operator makes a gesture, the first time at which the change of the face direction is started tends to be earlier than the first time in the mere line-of-sight movement relative to the second time at which the change of the line-of-sight direction is started.

On the basis of such knowledge, the gesture determination section according to the above mode uses the delay of the second time relative to the first time in the determination of the presence or absence of a gesture. According to the adoption of the above determination criterion, even at the stage when the difference between the line-of-sight direction and the face direction is small, the gesture determination section is capable of accurately determining that an input of a gesture is present on the basis of the difference between the start time of the change of the face direction and the start time of the change of the line-of-sight direction. As a result, it is possible to smoothly receive an input of a gesture while reducing erroneous determination. Thus, the gesture detection device having an excellent operability is achieved.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating an overview of an onboard configuration including a gesture detection device according to a first embodiment;

FIG. 2 is a diagram illustrating a state of an operator U who makes a gesture together with display of a display area;

FIG. 3 is a diagram illustrating the arrangement of a plurality of display areas around a driver's seat;

FIG. 4 is a diagram schematically illustrating a determination table which is used in the determination of a gesture and a line-of-sight movement;

FIG. 5 is a flowchart illustrating the details of a gesture detection process which is performed in the gesture detection device;

FIG. 6 is a graph illustrating an action of the operator when it is immediately determined that a gesture is present on the basis of the determination table;

FIG. 7 is a graph illustrating an action of the operator when it is determined that a gesture is present by accumulation of points based on the determination table;

FIG. 8 is a graph illustrating an action of the operator when it is immediately determined that a line-of-sight movement is present on the basis of the determination table;

FIG. 9 is a graph illustrating an action of the operator when it is determined that a line-of-sight movement is present by accumulation of points based on the determination table;

FIG. 10 is a block diagram illustrating an overview of a gesture detection device according to a second embodiment; and

FIG. 11 is a diagram schematically illustrating a determination table according to the second embodiment.

### EMBODIMENTS FOR CARRYING OUT INVENTION

### First Embodiment

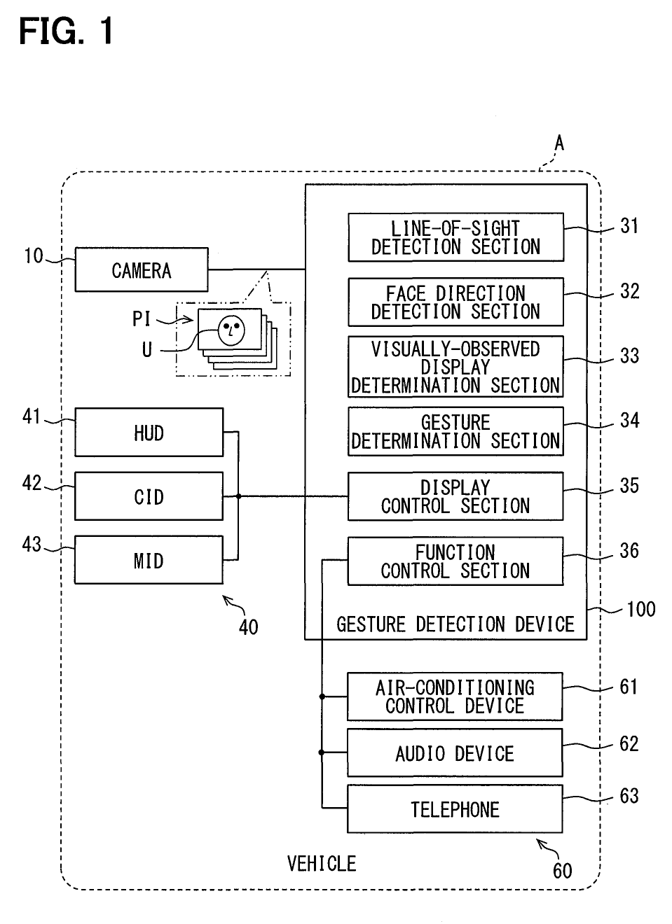

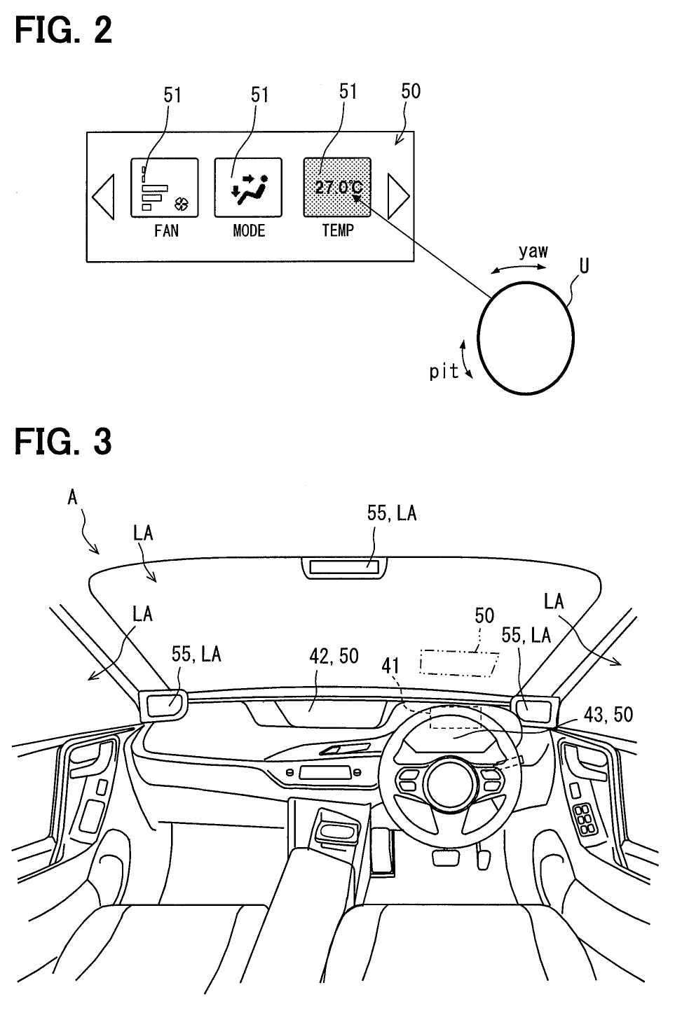

A gesture detection device 100 illustrated in FIGS. 1 and 2 according to a first embodiment of the present disclosure is mounted on a vehicle A. The gesture detection device 100 detects a gesture of an operator U who is a driver. The gesture is an action of the operator U who changes a face direction in an up-down (pitch) direction or a right-left (yaw) direction while visually observing an icon 51 which is displayed in a display area 50. The gesture detection device 100 controls an onboard device 60 which is associated with the visually-observed icon 51 (refer to dots in FIG. 2) in accordance with the detection of the gesture by the operator U. According to the function of the gesture detection device 100, the operator U can operate the onboard device 60 which is mounted on the vehicle A without using his/her hand during driving.

The gesture detection device 100 is electrically connected to a camera 10, a plurality of display devices 40, and a plurality of onboard devices 60.

The camera 10 is an imaging unit that captures an image of the operator U. The camera 10 includes an image sensor, a projector, and a control unit which controls the image sensor and the projector. The camera 10 is fixed inside a cabin of the vehicle A with an imaging surface of the image sensor facing a driver's seat. The camera 10 repeatedly captures an image of the face of the operator U and the surroundings thereof to which near infrared light is projected by the projector using the image sensor to generate a large number of captured images PI. The camera 10 successively outputs the generated large number of captured images PI to the gesture detection device 100.

The display devices 40 are interface devices which present information to the operator U by images displayed in the display area 50. Each of the display devices 40 displays various images in each display area 50 in accordance with a control signal acquired from the gesture detection device 100. The display devices 40 include a head-up display (HUD) 41, a center information display (CID) 42, and a multi-information display (MID) 43 (illustrated in FIGS. 1 and 3).

The HUD 41 projects light of an image which is generated in accordance with a control signal on the display area 50 which is set in, for example, a windshield or a combiner of the vehicle A. The image light reflected to the inside of the cabin by the display area 50 is perceived by the operator U who is seated on the driver's seat. The operator U can visually recognize a virtual image of the image projected by the HUD 41, the virtual image being superimposed on a scenery in front of the vehicle A. According to the above configuration, the HUD 41 is capable of displaying an image including the icon 51 (refer to FIG. 2) in the display area 50.

The CID 42 and the MID 43 are, for example, liquid crystal displays, and display an image including the icon 51 (refer to FIG. 2) which is generated in accordance with a control signal on a display screen as the display area 50. The CID 42 is installed, for example, above a center cluster inside the cabin. The MID 43 is installed, for example, at the front of the driver's seat. The display screen of each of the CID 42 and the MID 43 is visually recognizable from the operator U who is seated on the driver's seat.

The onboard devices 60 each acquire a control signal from the gesture detection device 100 illustrated in FIG. 1 and perform an operation according to the control signal. The onboard devices 60 include an air-conditioning control device 61, an audio device 62, and a telephone 63. The air-conditioning control device 61 is an electronic device that controls an air-conditioning device mounted on the vehicle A. The air-conditioning control device 61 changes a set temperature, an air volume, and an air direction of the air-conditioning device in accordance with a gesture of the operator U. The audio device 62 changes a track which is being played back and a sound volume in accordance with a gesture of the operator U. The telephone 63 sets a contact address and makes a telephone call to the set contact address in accordance with a gesture of the operator U.

The gesture detection device 100 is an electric circuit that has an image analysis function for analyzing the large number of captured images PI acquired from the camera 10 and a control function for controlling the display devices 40 and the onboard devices 60. The gesture detection device 100 is mainly composed of a microcomputer that includes at least one processor, a RAM, and a storage medium. The storage medium is, for example, a flash memory. The storage medium is a non-transitory tangible storage medium that stores information readable by the processor. The gesture detection device 100 includes a plurality of functional blocks by executing a gesture detection program stored in the storage medium by the processor. A line-of-sight detection section 31, a face direction detection section 32, a visually-observed display determination section 33, a gesture determination section 34, a display control section 35, and a device control section 36 are constructed in the gesture detection device 100.

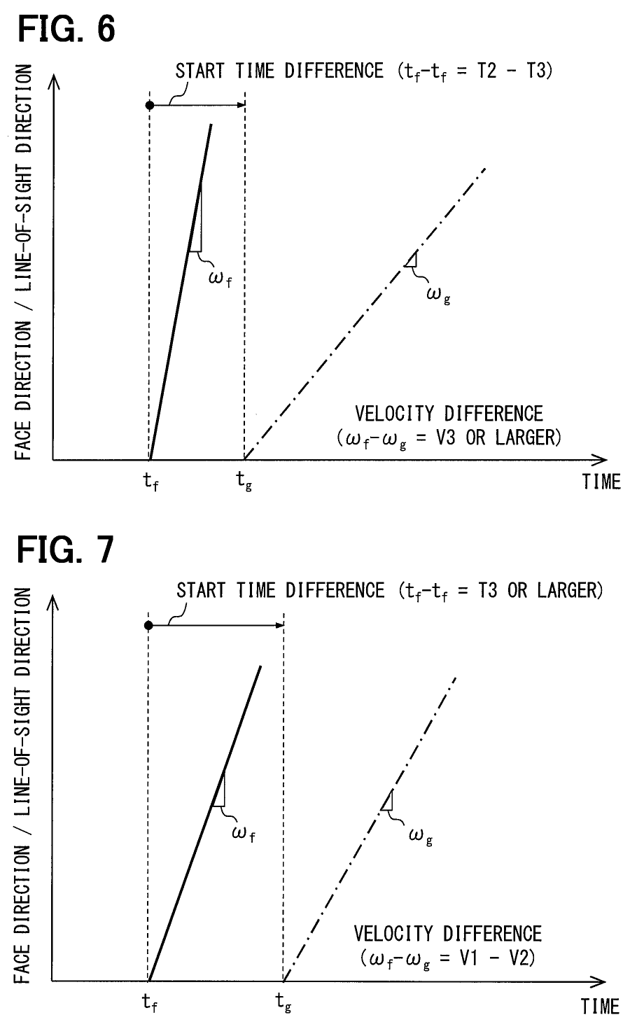

The line-of-sight detection section 31 detects a line-of-sight direction of the operator U from a series of captured images PI which are continuously captured. The line-of-sight detection section 31 identifies the position of an eye of the operator U in each of the captured images PI and further extracts the contour of the eye and the position of the iris. The line-of-sight detection section 31 calculates the line-of-sight direction of the operator U from the position of the iris inside the contour of the eye to identify a visually-observed position which is visually observed or closely observed by the operator U. In addition, when the operator U is changing the line-of-sight direction, the line-of-sight detection section 31 detects an angular velocity of the change of the line-of-sight direction as a line-of-sight moving velocity cog (refer to FIG. 6) on the basis of a transition of the change of the line-of-sight direction in each of the captured images PI.

The face direction detection section 32 detects a face direction of the operator U from a series of captured images PI which are continuously captured. The face direction detection section 32 extracts the positions of both eyes and the nose and the contour of the face of the operator U in each of the captured images PI. The face direction detection section 32 calculates a direction in which the face of the operator U is directed from the positions of the eyes and the nose inside the contour of the face. In addition, when the operator U is changing the face direction, the face direction detection section 32 detects an angular velocity of the change of the face direction as a face direction moving velocity ωf (refer to FIG. 6) on the basis of a transition of the change of the face direction in each of the captured images PI.

The visually-observed display determination section 33 determines whether the visually-observed position by the operator U is the display area 50 of each of the display devices 40, a check range LA for checking a condition outside the vehicle A, or a range other than the display area 50 and the check range LA on the basis of the line-of-sight direction of the operator U detected by the line-of-sight detection section 31. The check range LA includes, for example, ranges of the windshield and right and left side windows, and each display screen 55 of an electronic mirror system. The check range LA may include a back mirror and a side mirror instead of the display screen 55 of the electronic mirror system.

In addition, when the visually-observed display determination section 33 determines that the operator U visually observes the display area 50 in which the icons 51 (refer to FIG. 2) are displayed, the visually-observed display determination section 33 further determines one of the displayed icons 51 that is visually observed by the operator U. When the gesture determination section 34 determines that a line-of-sight movement (described below) is present, the visually-observed display determination section 33 further determines whether a destination of the line-of-sight movement of the operator U is the check range LA. When the visually-observed display determination section 33 determines that the destination of the line-of-sight movement is the check range LA, the visually-observed display determination section 33 maintains the determination of the visually-observed state on the icon 51 that is a visually-observed object by the operator U (immediately) before the line-of-sight movement. According to the above configuration, even when the operator U temporarily turns the line of sight away from the display area 50 to the check range LA to grasp the surrounding environment, the selected state of the specific icon 51 is maintained.

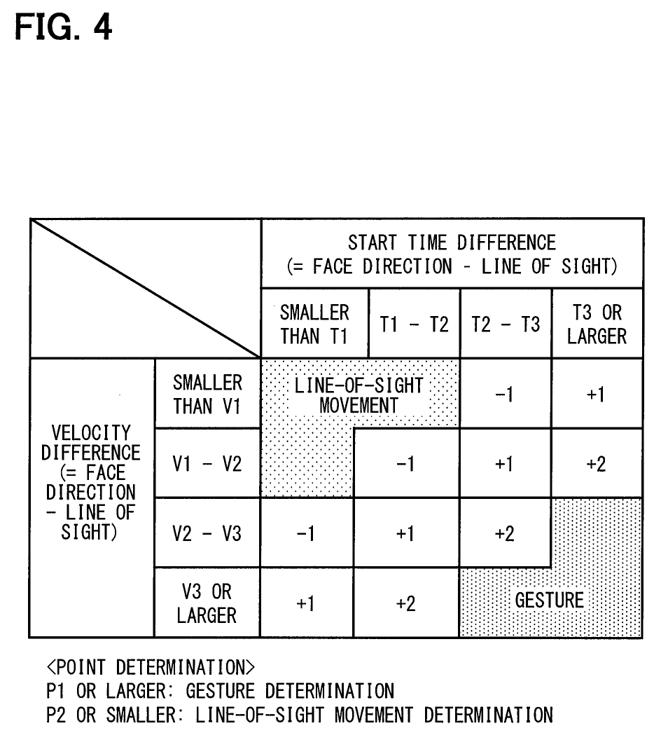

When there is a specific icon 51 (refer to FIG. 2) that is determined to be in a visually-observed state by the visually-observed display determination section 33, the gesture determination section 34 determines the presence or absence of a gesture to the icon 51. In addition, the gesture determination section 34 determines the presence or absence of a line-of-sight movement in which the operator U visually observing the display area 50 changes the visually-observed position to the outside of the display area 50. The gesture determination section 34 determines the presence or absence of the gesture and the line-of-sight movement using a determination table (refer to FIG. 4) on the condition that the difference between the line-of-sight direction and the face direction expands beyond an angle threshold which is previously defined.

The gesture determination section 34 identifies a line-of-sight change time tg (refer to FIG. 6) at which a change of the line-of-sight direction is started on the basis of a result of the detection by the line-of-sight detection section 31. The gesture determination section 34 identifies a face direction change time tf (refer to FIG. 6) at which a change of the face direction is started on the basis of a result of the detection by the face direction detection section 32. The gesture determination section 34 performs a comparison between the face direction change time tf and the line-of-sight change time tg to calculate a delay of the line-of-sight change time tg relative to the face direction change time tf. The start time difference (tf−tg) between the change of the line-of-sight direction and the change of the face direction is used as a determination criterion for determining the presence or absence of the gesture and the line-of-sight movement in the determination table (refer to FIG. 4).

In addition, the gesture determination section 34 calculates the difference between the face direction detected by the face direction detection section 32 and the line-of-sight direction detected by the line-of-sight detection section 31. Further, the gesture determination section 34 performs a comparison between the face direction moving velocity ωf detected by the face direction detection section 32 and the line-of-sight moving velocity cog detected by the line-of-sight detection section 31 to calculate the velocity difference (angular velocity difference) between the face direction moving velocity ωf and the line-of-sight moving velocity cog. The velocity difference (ωf−ωg) between the change of the line-of-sight direction and the change of the face direction is used as a determination criterion for determining the presence or absence of the gesture and the line-of-sight movement in the determination table (refer to FIG. 4).

The determination table (refer to FIG. 4) which is used in the gesture determination section 34 described above is set on the basis of new knowledge that a mode of an action performed by the operator U differs between a gesture and a line-of-sight movement. Specifically, when a mere line-of-sight movement is made, the operator U tends to change the line-of-sight direction first and then change the face direction. At this time, the line-of-sight moving velocity cog is apt to be higher than the face direction moving velocity ωf. On the other hand, when a gesture is made, the face direction change time tf at which the change of the face direction is started tends to be earlier than the face direction change time in a line-of-sight movement relative to the line-of-sight change time tg at which the change of the line-of-sight direction is started. At this time, the face direction moving velocity ωf is apt to be higher than the line-of-sight moving velocity ωg. The determination table is set on the basis of such a characteristic of the behavior of the operator U.

The gesture determination section 34 determines the presence or absence of a gesture and a line-of-sight movement on the basis of the delay of the line-of-sight change time tg relative to the face direction change time tf and the difference between the face direction moving velocity ωf and the line-of-sight moving velocity ωg by using the determination table (refer to FIG. 4). The gesture determination section 34 determines that a gesture is present when the delay of the line-of-sight change time tg relative to the face direction change time tf is larger than a gesture time threshold and the face direction moving velocity ωf is higher than the line-of-sight moving velocity ωg by more than a gesture velocity threshold. The gesture time threshold and the gesture velocity threshold are previously defined values. In the determination table, start time differences T2 and T3 correspond to the gesture time threshold, and velocity differences V2 and V3 correspond to the gesture velocity threshold. Specifically, when the start time difference is equal to or larger than T3 and the velocity difference is equal to or larger than V2, or when the start time difference is equal to or larger than T2 and the velocity difference is equal to or larger than V3, the gesture determination section 34 determines that a gesture is present.

On the other hand, the gesture determination section 34 determines that a line-of-sight movement is present when the delay of the line-of-sight change time tg relative to the face direction change time tf is smaller than a line-of-sight time threshold and the face direction moving velocity ωf is higher than the line-of-sight moving velocity ωg by less than a line-of-sight velocity threshold. The line-of-sight time threshold is previously set to a time equal to or shorter than the gesture time threshold or a time shorter than the gesture time threshold, and corresponds to start time differences T1 and T2 in the determination table (refer to FIG. 4). Similarly, the line-of-sight velocity threshold is previously set to a value equal to or smaller than the gesture velocity threshold or a value smaller than the gesture velocity threshold, and corresponds to velocity differences V1 and V2 in the determination table.

According to the above setting, when the start time difference is smaller than T2 and the velocity difference is smaller than V1 or when the start time difference is smaller than T1 and the velocity difference is smaller than V2, the gesture determination section 34 determines that a line-of-sight movement is present. In addition, also when the line-of-sight change time tg is earlier than the face direction change time tf, and when the line-of-sight moving velocity ωg is higher than the face direction moving velocity cot the gesture determination section 34 determines that a line-of-sight movement is present.

When the gesture determination section 34 determines that neither a gesture nor a line-of-sight movement is present, the gesture determination section 34 re-determines the presence or absence of a gesture and a line-of-sight movement on the basis of new pieces of information of the line-of-sight direction detected by the line-of-sight detection section 31 and the face direction detected by the face direction detection section 32. A point is set in a range that corresponds to neither a gesture nor a line-of-sight movement in the determination table (refer to FIG. 4). When the gesture determination section 34 repeatedly performs the re-determination, the gesture determination section 34 adds up points corresponding to the start time difference and the velocity difference. When an action that is more similar to an action of a gesture than to a line-of-sight movement has been detected, a plus point is added. When a value of the accumulated points becomes equal to or larger than an upper limit point threshold P1 which is previously set, the gesture determination section 34 determines that a gesture is present. On the other hand, when an action that is more similar to an action of a line-of-sight movement than to a gesture has been detected, a minus point is added. When a value of the accumulated points becomes equal to or smaller than a lower limit point threshold P2 which is previously set, the gesture determination section 34 determines that a line-of-sight movement is present.

With such a determination based on the accumulated points, when the gesture determination section 34 has derived a determination result that an action similar to a gesture has been detected in the past determination, the gesture determination section 34 easily determines that a gesture is present in the next re-determination by reflecting the past determination result. Similarly, when the gesture determination section 34 has derived a determination result that an action similar to a line-of-sight movement has been detected in the past determination, the gesture determination section 34 easily determines that a line-of-sight movement is present in the next re-determination by reflecting the past determination result.

The display control section 35 generates a control signal output to each of the display devices 40 to control a mode of display in each of the display areas 50. The display control section 35 displays a plurality of icons 51 in at least one display area 50 of each of the display devices 40 in a state in which an input by a gesture is possible. In addition, the display control section 35 highlights a specific icon 51 that is determined to be in a visually-observed state by the operator U by the visually-observed display determination section 33.

In addition, the display control section 35 causes a display mode of each of the display areas 50 to continuously transition in conjunction with the determination of the presence or absence of a gesture and a line-of-sight movement by the gesture determination section 34. Specifically, when it is determined that a gesture is present, the display control section 35 changes the display of the display area 50 to a first display mode which notifies the operator U that the gesture has been received. In the first display mode, for example, four edges of the display area 50 that displays the icons 51 are temporarily highlighted, and information is then updated to the contents of the selected icon 51.

When it is determined that there is a line-of-sight movement from one of the display areas 50 to another one of the display areas 50, the display control section 35 changes the display of each of the display areas 50 to a second display mode which notifies the operator U that the line-of-sight movement has been performed. In the second display mode, for example, four edges of the display area 50 that is a destination of the line-of-sight movement are temporarily highlighted.

Further, the display control section 35 controls the display of each of the display areas 50 to a transition display mode in a period during which the gesture determination section 34 performs the re-determination. In the transition display mode, for example, four edges of the display area 50 that displays the icons 51 are highlighted lighter than the first display mode. In addition, in another display area 50 that is a candidate for the destination of the line-of-sight movement, one edge closest to the display area 50 that is a departure point of the line-of-sight movement is highlighted lighter than the second display mode. As described above, according to the transition display mode corresponding to both a transition to the first display mode and a transition to the second display mode, the highlight of each of the display areas 50 is gradually enhanced both when it is determined that a gesture is present and when it is determined that a line-of-sight movement is present.

The device control section 36 generates a control signal output to each of the onboard devices 60 to control the operation of each of the onboard devices 60. When the gesture determination section 34 determines that a gesture is present, the device control section 36 generates and outputs the control signal so that control associated with the icon 51 that is determined to be a visually-observed object by the visually-observed display determination section 33 is executed.

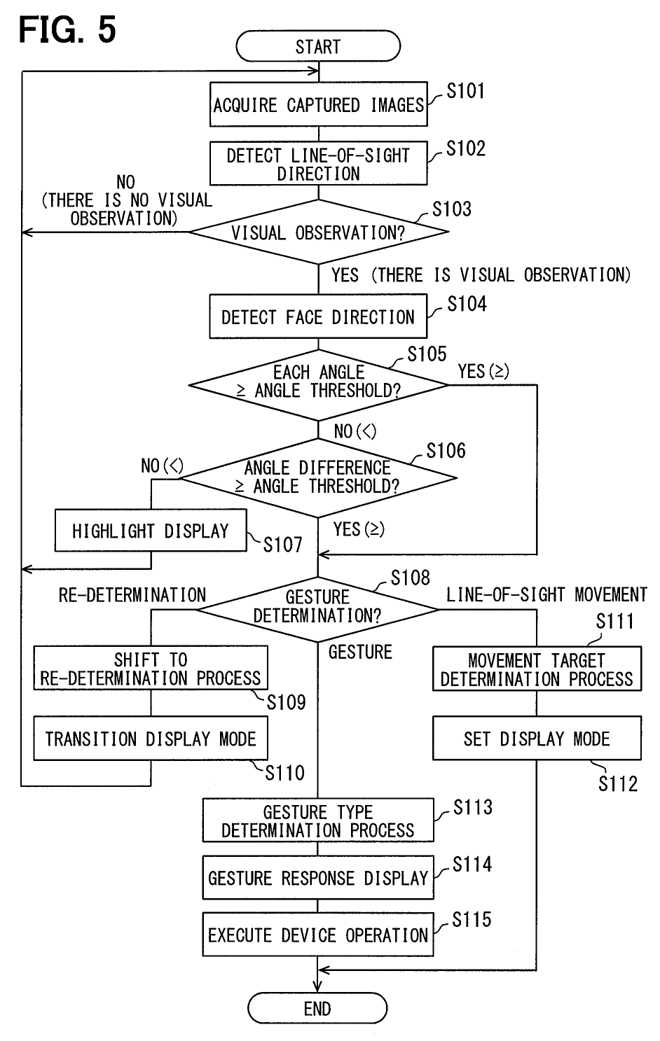

The details of a gesture detection process performed by the gesture detection device 100 described above will be described with reference to FIG. 5, and further to FIGS. 1 to 4. The gesture detection process is started, for example, when the icon 51 is displayed in the display area 50 and an input mode in which a gesture operation is possible becomes an ON state. The gesture detection process is repeatedly started until the input mode in which the gesture operation is possible becomes an OFF state.

In S101, a plurality of frames of captured images PI are acquired from the camera 10, and the process proceeds to S102. In S102, the line-of-sight direction and the line-of-sight moving velocity ωg of the operator U are detected from the captured images PI acquired in S101, and the process proceeds to S103. In S103, it is determined whether there is a visual observation to the icon 51 displayed in the display area 50 on the basis of the line-of-sight direction detected in the preceding S102. When it is determined that there is no visual observation to the icon 51 in S103, the process returns to S101. On the other hand, when it is determined that there is a visual observation to the icon 51 in S103, the process proceeds to S104.

In S104, the face direction and the face direction moving velocity ωf of the operator U are detected from the captured images PI acquired in S101, and the process proceeds to S105. In S105, it is determined whether each of the angle indicating the line-of-sight direction detected in the preceding S102 and the angle indicating the face direction detected in the preceding S104 is equal to or larger than an angle threshold which is previously defined for each of the angles. Each of the angle indicating the line-of-sight direction and the angle indicating the face direction is an angle between a virtual axis extending from the position of the iris of the operator to the icon 51 determined in S103 and each of a virtual axis indicating the line-of-sight direction and a virtual axis indicating the face direction. When at least either the angle indicating the line-of-sight direction or the angle indicating the face direction is equal to or larger than the angle threshold in S105, the process proceeds to S108. On the other hand, when the angle indicating the line-of-sight direction and the angle indicating the face direction are both smaller than the respective angle thresholds, the process proceeds to S106.

In S106, it is determined whether the angle difference which is the difference between the line-of-sight direction detected in the preceding S102 and the face direction detected in the preceding S104 is equal to or larger than the angle threshold. The angle difference is an angle between the virtual axis indicating the line-of-sight direction and the virtual axis indicating the face direction. When it is determined that the angle difference between the line-of-sight direction and the face direction is smaller than the angle threshold in S106, the process proceeds to S107. In S107, the icon 51 that is determined to be visually observed in S103 is highlighted, and the process returns to S101. On the other hand, when it is determined that the angle difference is equal to or larger than the angle threshold in S106, the process proceeds to S108.

In S108, the determination of the presence or absence of a gesture and a line-of-sight movement based on the determination table is performed. In S108, the start time difference between the face direction change time tf and the line-of-sight change time tg and the velocity difference between the face direction moving velocity ωf and the line-of-sight moving velocity ωg are calculated, and the calculated results are applied to the determination table. When it is determined that neither a gesture nor a line-of-sight movement is present on the basis of the determination table, the process proceeds to S109 and shifts to a re-determination process. Along with the shift to the re-determination process, the display of at least one display area 50 is changed to the transition display mode in S110, and the process returns to S101.

When it is determined that a line-of-sight movement is present in S108, the process proceeds to S111. In S111, a destination of the line-of-sight movement is determined by performing a movement target determination process, and the process proceeds to S112. In S112, display modes of one or more display areas 50 are set on the basis of a determination result in S112. When it is determined that the line-of-sight has moved from one display area 50 to another display area 50 in S112, the display of the other display area 50 is changed to the second display mode in S112. When it is determined that the line-of-sight has moved to the check range LA in S111, a display state before the line-of-sight movement, that is, an operation screen in which a specific icon 51 is in a selected state is maintained in the display of the display area 50 that is the movement departure point in S112. After the display control by S112 is completed, the gesture detection process is temporarily finished.

When it is determined that a gesture is present in S108, the process proceeds to S113. In S113, a type of the detected gesture is determined, and the process proceeds to S114. In S113, for example, it is determined whether a gesture in a pitch direction in which the operator U shakes his/her face up and down has been made or a gesture in a roll direction in which the operator U shakes his/her face right and left has been made. In S114, the display of the display area 50 is changed to a display corresponding to the gesture determined in S113, and the process proceeds to S115. The display change by S114 is a response display to the gesture and has a function of notifying the operator U that the gesture has been received.

In S115, an operation of the onboard device 60 corresponding to the type of the gesture determined in S113 is executed. In S115, a control signal corresponding to the icon 51 in a selected state is generated, and the generated control signal is output to the onboard device 60 to be operated. After the device operation by S115 is completed, the gesture detection process is temporarily finished.

Concrete examples of the determination of the presence or absence of a gesture and a line-of-sight movement based on the determination table described above will be described in order with reference to FIGS. 6 to 9, and further to FIGS. 1 and 4.

In a behavior of the operator U illustrated in FIG. 6, the start time difference between the face direction change time tf and the line-of-sight change time tg is a value between T2 and T3. In addition, the velocity difference between the face direction moving velocity ωf and the line-of-sight moving velocity ωg is a value equal to or larger than V3. In such a behavior of the operator U, the gesture determination section 34 determines that a gesture is present on the basis of the determination table at the stage when the angle difference between the line-of-sight direction and the face direction becomes equal to or larger than the angle threshold. In this case, a characteristic peculiar to a gesture remarkably appears in both the start time difference and the velocity difference. Thus, even when the angle threshold is set to a small value, erroneous determination of a gesture is reduced.

In a behavior of the operator U illustrated in FIG. 7, the start time difference between the face direction change time tf and the line-of-sight change time tg is a value equal to or larger than T3. In addition, the velocity difference between the face direction moving velocity ωf and the line-of-sight moving velocity ωg is a value between V1 and V2. When the behavior of the operator U similar to a gesture has been detected in this manner, the gesture determination section 34 adds “+2” points on the basis of the determination table and shifts the process to the re-determination process. Then, at the stage when a value of the accumulated points becomes equal to or larger than the upper limit threshold P1, the gesture determination section 34 determines that a gesture is present. As described above, the gesture determination section 34 is capable of determining that a gesture is present within a shorter time for a behavior that is difficult to determine to be a gesture by taking the progress of the behavior of the operator U into consideration.

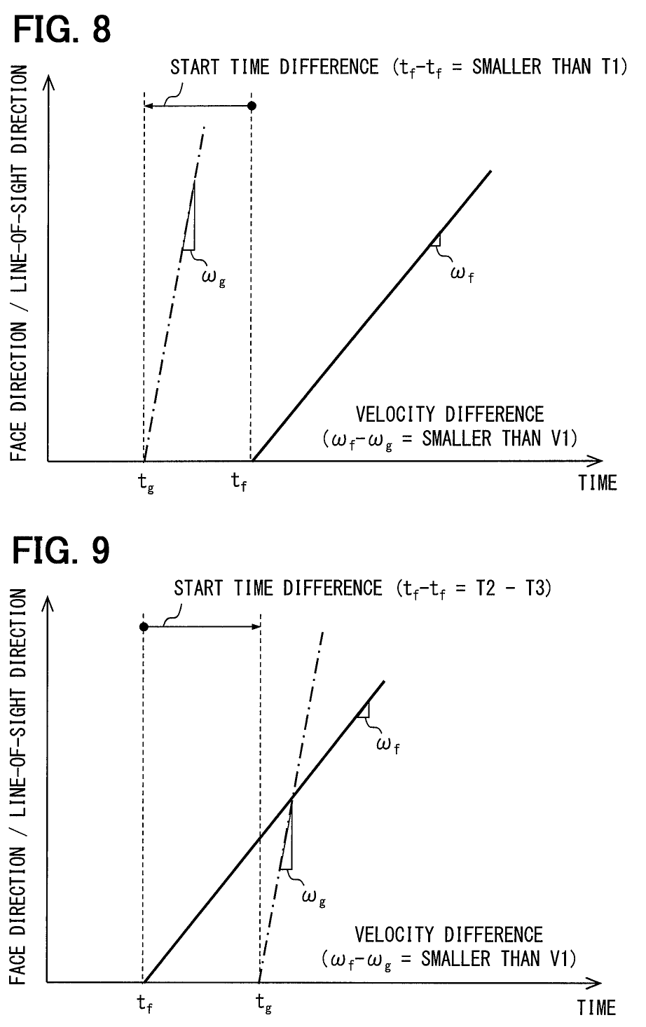

In a behavior of the operator U illustrated in FIG. 8, the line-of-sight change time tg precedes the face direction change time tf. As a result, the start time difference between the face direction change time tf and the line-of-sight change time tg is a value smaller than T1. Further, the line-of-sight moving velocity ωg is a value higher than the face direction moving velocity ωf. As a result, the velocity difference between the face direction moving velocity ωf and the line-of-sight moving velocity ωg is a value smaller than V1. In such a behavior of the operator U, the gesture determination section 34 determines that a line-of-sight movement is present on the basis of the determination table at the stage when the angle difference between the line-of-sight direction and the face direction becomes equal to or larger than the angle threshold. In this case, a characteristic peculiar to a line-of-sight movement remarkably appears in both the start time difference and the velocity difference. Thus, even when the angle threshold is set to a small value, erroneous detection of a line-of-sight movement is reduced.

In a behavior of the operator U illustrated in FIG. 9, the start time difference between the face direction change time tf and the line-of-sight change time tg is a value between T2 and T3. On the other hand, the line-of-sight moving velocity ωg is a value higher than the face direction moving velocity ωf. When the behavior of the operator U similar to a line-of-sight movement has been detected in this manner, the gesture determination section 34 adds “−1.” point on the basis of the determination table, and shifts the process to the re-determination process. At the stage when a value of the accumulated points becomes equal to or smaller than the lower limit point threshold P2, the gesture determination section 34 determines that a line-of-sight movement is present. As described above, the gesture determination section 34 is capable of determining that a line-of-sight movement is present within a shorter time for a behavior that is difficult to determine to be a line-of-sight movement by taking the progress of the behavior of the operator U into consideration.

In the first embodiment described above, the gesture determination section 34 uses the delay of the line-of-sight change time tg relative to the face direction change time tf, that is, the opening time difference in the determination of the presence or absence of a gesture on the basis of new knowledge relating to the behavior of the operator U. According to the adoption of the above determination criterion, even at the stage when the angle difference between the line-of-sight direction and the face direction is small, the gesture determination section 34 is capable of accurately determining that an input of a gesture is present on the basis of the difference between the time of the change of the face direction and the time of the change of the line-of-sight direction. As a result, it is possible to smoothly receive an input of a gesture while reducing erroneous determination. Thus, the gesture detection device 100 having an excellent operability is achieved.

In addition, in the first embodiment, the gesture determination section 34 further uses the velocity difference between the face direction moving velocity (of and the face direction moving velocity (of in the determination of the presence or absence of a gesture on the basis of new knowledge relating to the behavior of the operator U. According to the further adoption of such a determination criterion, even at the stage when the angle difference between the line-of-sight direction and the face direction is small, the gesture determination section 34 is capable of accurately determining that an input of a gesture is present by combining the start time difference and the velocity difference. According to the above configuration, an input of a gesture is detected more quickly and more accurately while further reducing erroneous determination.

In the first embodiment, the gesture determination section 34 determines the presence or absence of a gesture and a line-of-sight movement using the determination table in which the multistage thresholds are set for each of the start time difference and the velocity difference. In the mode in which the behavior of the operator U is determined using the determination table as described above, the gesture determination section 34 is capable of quickly determining the presence or absence of a gesture and a line-of-sight movement.

When the gesture determination section 34 of the first embodiment determines that neither a gesture nor a line-of-sight movement is present, the gesture determination section 34 performs the re-determination process on the basis of new information. The gesture determination section 34 is capable of determining that a gesture is present and a line-of-sight is present by the process of accumulating points taking a transition of the behavior of the operator U into consideration. According to the above configuration, the gesture determination section 34 is capable of determining that a gesture is present at an earlier time by reflecting the past determination result even for an action similar to a gesture that is difficult to clearly determine to be a gesture. Similarly, the gesture determination section 34 is capable of determining that a line-of-sight movement is present at an earlier time by reflecting the past determination result even for an action similar to a line-of-sight movement that is difficult to clearly determine to be a line-of-sight movement.

Further, in the first embodiment, when the gesture determination section 34 performs re-determination, the display of each of the display areas 50 is in the transition display mode corresponding to both a transition to the first display mode and a transition to the second display mode. According to the above configuration, even when a period of re-determination is generated by a vague action of the operator U, the display of each display area 50 is switched in stages until the determination is finalized. As a result, the operator U can obtain a more excellent operability by the display that changes in response to the behavior of the operator U.

In addition, according to the first embodiment, when the destination of the line-of-sight movement is the check range LA, the determination of a visually-observed state on the icon 51 that has been a visually-observed object by the operator U before the line-of-sight movement is maintained. As a result, even when the operator U turns the line of sight away from the display area 50 to the check range LA to grasp a surrounding traveling environment, the selected state of the specific icon 51 is maintained. According to the above configuration, the display of the display area 50 in operation is maintained. Thus, the operator U can promptly restart the operation of the onboard device 60 by a gesture after returning the line of sight to the display area 50 from the check range LA.

In the first embodiment, the camera 10 corresponds to an “imaging unit”, and the icon 51 corresponds to a “target display object”. The face direction change time tf corresponds to a “first time”, the line-of-sight change time tg corresponds to a “second time”, the face direction moving velocity ωf corresponds to a “first velocity”, and the line-of-sight moving velocity ωg corresponds to a “second velocity”.

### Second Embodiment

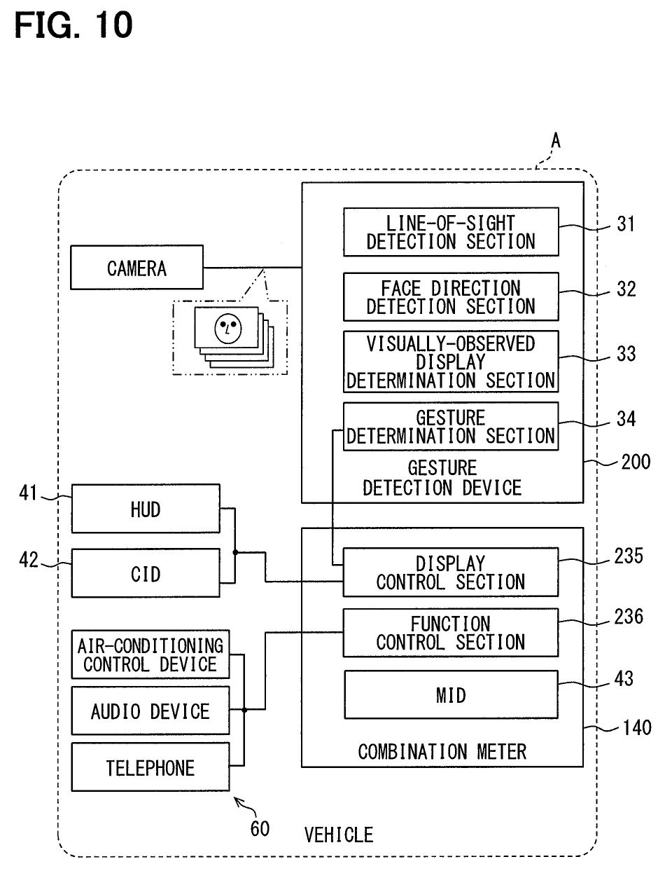

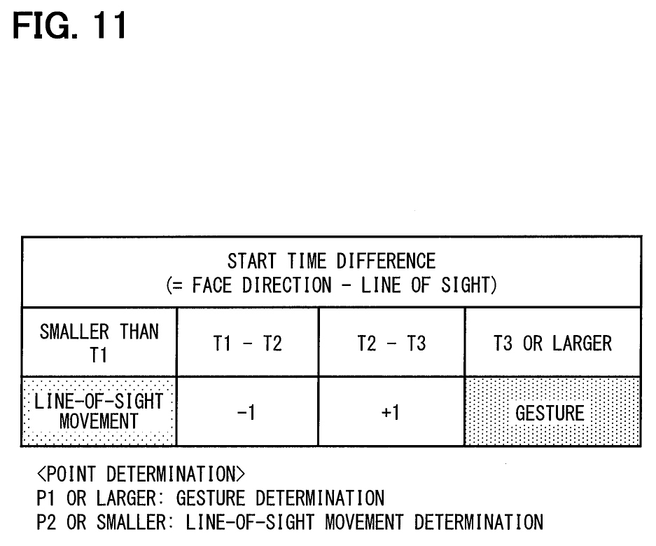

A second embodiment of the present disclosure illustrated in FIGS. 10 and 11 is a modification of the first embodiment. A gesture detection device 200 according to the second embodiment is connected to a combination meter 140 which is one of display devices mounted on a vehicle A. In the second embodiment, some of the functions of the gesture detection device 100 (refer to FIG. 1) of the first embodiment are implemented by the combination meter 140. A determination table of the second embodiment is simpler than the determination table of the first embodiment. Hereinbelow, the details of the gesture detection device 200 according to the second embodiment will be described in order.

The gesture detection device 200 constructs a line-of-sight detection section 31, a face direction detection section 32, a visually-observed display determination section 33, and a gesture determination section 34, which are substantially the same as those of the first embodiment, by executing a gesture detection program. On the other hand, functional sections corresponding to the display control section 35 and the device control section 36 (refer to FIG. 1) are not constructed in the gesture detection device 200.

The combination meter 140 is a vehicle display device that includes an MID 43 and a control circuit. The control circuit is mainly composed of a microcomputer that includes at least one processor, a RAM, and a storage medium. The combination meter 140 constructs a display control section 235 and a device control section 236 by executing a display control program by the processor.

The display control section 235 is a functional section corresponding to the display control section 35 (refer to FIG. 1) of the first embodiment. The display control section 235 acquires a determination result of a gesture and a line-of-sight movement from the gesture determination section 34. The display control section 235 controls display of each of an HUD 41 and a CID 42 in addition to display of the MID 43 on the basis of the acquired determination result.

The device control section 236 is a functional section corresponding to the device control section 36 (refer to FIG. 1) of the first embodiment. The device control section 236 sets an onboard device 60 that is an operational object by a gesture and specific details of control relating to an icon 51 (refer to FIG. 2) in a selected state. The device control section 236 executes control for operating each onboard device 60 on the basis of the determination result acquired by the display control section 235.

In the determination table of the second embodiment, a gesture time threshold and a line-of-sight time threshold which are substantially the same as those of the first embodiment, that is, T1 to T3 are set. On the other hand, in the determination table, a gesture velocity threshold and a line-of-sight velocity threshold, that is, V1 to V3 (refer to FIG. 4) of the first embodiment are not set. The gesture determination section 34 determines the presence or absence of a gesture and a line-of-sight movement on the basis of only a start time difference in a process corresponding to S108 (refer to FIG. 5) on the basis of the determination table as described above.

Specifically, the gesture determination section 34 determines that a line-of-sight movement is present when the start time difference is smaller than T1. The gesture determination section 34 determines that a gesture is present when the start time difference is equal to or larger than T3. The gesture determination section 34 shifts the process to a re-determination process (refer to S107 in FIG. 5) when the start time difference is equal to or larger than T1 and smaller than T3. In the re-determination process, when the start time difference is equal to or larger than T1 and smaller than T2, a point is subtracted from the accumulated points. On the other hand, when the start time difference is equal to or larger than T2 and less than T3, a point is added to the accumulated points. According to the above configuration, also when the determination table of FIG. 10 is used, the gesture determination section 34 is capable of determining the presence of each of a gesture and a line-of-sight movement by using the accumulated points.

The second embodiment described above also achieves an effect similar to the effect of the first embodiment and achieves both reduction of erroneous determination and a smooth input of a gesture by using the start time difference as a determination criterion. In addition, the gesture detection device 200 may provide a result of the detection of a gesture and a line-of-sight movement to the display control section 235 and the device control section 236 outside the device. Even when the velocity difference is not used as a determination criterion as in the second embodiment, the gesture determination section 34 is capable of detecting a gesture and a line-of-sight movement with a higher accuracy than a conventional technique.

### Other Embodiments

While the embodiments of the present disclosure have been described above, the present disclosure is not limited to the above embodiments and is applicable to various embodiments and combinations without departing from the gist of the present disclosure.

In the above first embodiment, a plurality of thresholds are set in stages for each of the start time difference and the velocity difference, and a plurality of threshold groups are combined to define the determination table. Further, the gesture determination section determines the presence or absence of a gesture and a line-of-sight movement on the basis of the determination table. However, a specific method of the determination process performed by the gesture determination section may be appropriately changed as long as the start time difference and the velocity difference are used. For example, the gesture determination section is capable of determining the presence or absence of a gesture and a line-of-sight movement by using a discriminator which is previously defined by machine learning. The discriminator is capable of outputting a determination result of the presence or absence of a gesture and a line-of-sight movement by receiving the start time difference, or both the start time difference and the velocity difference as an input.

When the gesture determination section of the above embodiments determines that neither a gesture nor a line-of-sight movement is present, the gesture determination section performs the re-determination. However, the gesture determination section may temporarily finish the gesture detection process without performing the re-determination. In addition, in the re-determination of the above embodiments, it is easy to determine the presence of a gesture or a line-of-sight movement by taking the transition of the behavior of the operator U into consideration. However, a condition that the presence of a gesture and a line-of-sight movement is determined in the re-determination may be the same as the condition in the first determination. That is, the gesture determination section may not perform the determination of a gesture and a line-of-sight movement based on the accumulation points.

In the above embodiments, the three display devices: the HUD; the CID; and the MID are used so that information can be provided to the operator through a plurality of display areas. However, the number and the size of display areas can be appropriately changed. In addition, the form, the display position, and the displayed number of icons for a gesture may be appropriately changed according to the number and the size of display areas defined around the driver's seat. Further, a specific configuration of the display device that implements display of the display area is not limited to the configuration of the above embodiments. Further, the display control section may not perform the control for bringing the display of each display area into the transition display mode during re-determination.

In the above embodiments, when the line of sight is moved to the check range LA to check the surroundings of the vehicle A, a selected state of the specific icon is maintained. However, such a process may not be performed. The selected state of the specific icon may be temporarily cancelled in response to a displacement of the visually-observed position from the display area.

In the above embodiments, the electronic circuit of the gesture detection device which is mainly composed of the microcomputer executes the gesture detection program. However, a specific configuration that executes the gesture detection program and the gesture detection method based on the gesture detection program may be hardware and software different from the configuration of the above embodiments or a combination thereof. For example, a control circuit of a navigation device mounted on the vehicle A may function as the gesture detection device. Further, the control unit of the camera that captures an image of the operator may function as the gesture detection device.

In the above embodiments, there has been described an example in which the characteristic part of the present disclosure is applied to the gesture detection device mounted on the vehicle A. However, the gesture detection device is not limited to a mode mounted on the vehicle. For example, the characteristic part of the present disclosure is applicable to a gesture detection device that is employed as an input interface of various electronic devices such as a portable terminal, a personal computer, and a medical device.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A gesture detection device that detects a gesture of an operator who changes a face direction while visually observing a target display object displayed in a display area, the gesture detection device comprising:
a line-of-sight detection section that detects a line-of-sight direction of the operator according to a captured image of an imaging unit that captures an image of the operator;
a face direction detection section that detects a face direction of the operator according to the captured image; and
a gesture determination section that compares a first time at which the operator starts changing the face direction with a second time at which the operator starts changing the line-of-sight direction, and determines whether the gesture is performed with respect to the target display object, according to a delay of the second time relative to the first time h addition to an expansion of a difference between the line-of-sight direction and the face direction.

2. The gesture detection device according to claim 1, wherein:
the face direction detection section detects an angular velocity of changing the face direction by the operator as a first velocity;
the line-of-sight detection section detects an angular velocity of changing the line-of-sight direction by the operator as a second velocity; and
the gesture determination section determines whether the gesture is performed, according to a difference between the first velocity and the second velocity in addition to the expansion of the difference between the line-of-sight direction and the face direction and the delay of the second time relative to the first time.

3. The gesture detection device according to claim 2, wherein:
the gesture determination section determines that the gesture is performed when the first velocity is higher than the second velocity by more than a gesture velocity threshold that is preliminarily determined.

4. The gesture detection device according to claim 3, wherein:
the gesture determination section determines that the operator moves the line-of-sight when the first velocity is higher than the second velocity by less than a line-of-sight velocity threshold that is lower than the gesture velocity threshold or when the second velocity is higher than the first velocity in a case where the difference between the line-of-sight direction and the face direction expands.

5. The gesture detection device according to claim 1, wherein:
the gesture determination section determines that the gesture is performed when the delay of the second time relative to the first time is larger than a gesture time threshold that is preliminarily determined.

6. The gesture detection device according to claim 5, wherein:
the gesture determination section determines that the operator moves the line-of-sight when the delay of the second time relative to the first time is smaller than a line-of-sight time threshold that is shorter than the gesture time threshold or when the second time is earlier than the first time in a case where the difference between the line-of-sight direction and the face direction expands.

7. The gesture detection device according to claim 4, wherein:
when the gesture determination section determines that neither the gesture nor a line-of-sight movement is performed, the gesture determination section determines again whether the gesture or the line-of-sight movement is performed, according to new pieces of information of the line-of-sight direction and the face direction.

8. The gesture detection device according to claim 7, wherein:
when the gesture determination section derives a determination result that an action of the operator is more similar to an action of the gesture than to the line-of-sight movement in a past determination result, the gesture determination section reflects the past determination result on a re-determination result to easily determine that the gesture is performed.

9. The gesture detection device according to claim 7, wherein:
when the gesture determination section derives a determination result that an action of the operator is more similar to an action of the line-of-sight movement than to the gesture in a past determination result, the gesture determination section reflects the past determination result on a re-determination result to easily determine that the line-of-sight movement is performed.

10. The gesture detection device according to claim 7, further comprising:
a display controller that controls a display of the display area to be in a first display mode when the gesture determination section determines that the gesture is performed, and controls the display of the display area to be in a second display mode when the gesture determination section determines that the line-of-sight movement is performed, wherein:
the display controller controls the display of the display area to be in a transition display mode corresponding to each of a transition to the first display mode and a transition to the second display mode in a period during which the gesture determination section performs re-determination.

11. The gesture detection device mounted on a vehicle according to claim 4, the gesture detection device further comprising:
a visually-observed display determination section that determines the target display object visually observed by the operator, according to the line-of-sight direction detected by the line-of-sight detection section, wherein:
the visually-observed display determination section further determines whether a destination of the line-of-sight movement is disposed within a check area for checking a condition outside the vehicle when the gesture determination section determines that the line-of-sight movement is performed; and
the visually-observed display determination section maintains a determination of a visually-observed state with respect to the target display object that is a visually-observed object by the operator before the line-of-sight movement when the visually-observed display determination section determines that the destination of the line-of-sight movement is disposed within the check area.
